(19) United States
(12) Patent Application Publication
(10) Pub. No.: US 2026/0253443 A1
(43) Pub. Date: Aug. 27, 2026

(54) METHOD AND SYSTEM FOR GENERATING A HAND POSE

(71) Applicant: Samsung Electronics Co., Ltd., Suwon-si (KR)

(72) Inventors: Green Rosh K S, Bangalore (IN); Bindigan Hariprasanna Pawan PRASAD, Bangalore (IN); Vishakha S R, Bangalore (IN); Prateek KUKREJA, Bangalore (IN); Akula JAYAPRAKASH, Bangalore (IN); Shubham Mallik THAKUR, Bangalore (IN); Meghana SHANKAR, Bangalore (IN); Sagar PARMAR, Bangalore (IN); Mukesh JHA, Bangalore (IN); Sungsoo CHOI, Suwon-si (KR); Hyuntaek WOO, Suwon-si (KR); Chaeeun LEE, Suwon-si (KR); Beomsu KIM, Suwon-si (KR)

(21) Appl. No.: 19/648,602

(22) Filed: Apr. 15, 2026

Related U.S. Application Data
(63) Continuation of application No. PCT/KR2024/020724, filed on Dec. 19, 2024.

(30) Foreign Application Priority Data
Dec. 21, 2023 (IN) 202341087753

(51) Int. Cl. G06V 40/10; G06V 10/26; G06F 3/01

(52) U.S. Cl. CPC G06V 40/11; G06V 10/26; G06F 3/011

(57) ABSTRACT

A system (102) to generate a hand pose and includes a map-generating module that generates a hand map (300) a plurality of key points (302) from an input image of a hand. The system (102) also includes an identification module (210) that identifies an offset key point (314, kp1) out of the plurality of key points (302) located outside the hand map (300) and identify a reference key point (316, kp2) located inside the hand map (300) closest to the offset key point (314, kp1). In addition, the system (102) includes a modification module (214) that rotates the offset key point (314, kp1) to a new position at an intersection of the path of the rotation and the hand map (300). Finally, the system (102) includes a hand-pose generation module (216) that generates the hand pose subsequent to the shifting.

### CROSS-REFERENCE TO RELATED APPLICATIONS

This application is a continuation application, claiming priority under 35 U.S.C. § 365(c), of an International application No. PCT/KR2024/020724, filed on December 19, 2024, which is based on and claims the benefit of an Indian patent application number 202341087753, filed on December 21, 2023 in the Indian Patent Office, the disclosure of which is incorporated by reference herein in its entirety.

### BACKGROUND

### 1. Field

The present disclosure relates to systems and methods for generating a hand pose and, more particularly, shifting key points to generate an accurate hand pose.

### 2. Description of Related Art

Hand pose generation refers to the process of capturing, representing, and often reconstruction of the three-dimensional (3D) position and orientation of the human hand in a digital format. Hand pose generation is commonly used in fields such as computer vision, augmented reality (AR), virtual reality (VR), and human-computer interaction.

The hand pose generation process is generally performed by capturing a 2-dimensional image of a user's hand and identifying an outline of the user's hand including the palm and fingers of the user's hand. Thereafter, the hand pose can be determined from the orientation of the fingers and, based on the determined orientation, the hand pose is generated. The hand pose can be either displayed on a screen or rendered in an AR/VR environment. Generally, each finger is identified as a plurality of nodes that are connected to each other by lines. To improve the accuracy of the hand pose generation, deep learning algorithms are implemented.

There are various limitations associated with the current process of generating the hand pose. Existing techniques and processes encounter issues when generating a hand pose when the user's fingers overlap, for instance, when the user crosses the fingers. This can cause the generated hand pose to be inaccurate or, in some cases, distorted. As a result, the generated hand map is also inaccurate. One approach to mitigate this issue is to identify a node outside the detected outline of the hand, and then perform a brute-force search of a large section of the image surrounding the outside node to detect the outline of the hand. However, this approach is computationally intensive and time-consuming. Moreover, such a process also changes the length of the lines between the outside node and the consecutive node. A change in length also cause the node, that was previously inside the outline, to shift outside and additional correction is needed to shift the outside node to the inside.

Therefore, existing techniques of hand pose generation are computationally resource intensive and encounter issues to accurately generate the hand pose. Accordingly, there is a need for methods and systems for generating hand poses by obviating at least the aforementioned issues. It is generally desirable to overcome or ameliorate one or more of the above-described difficulties, or to at least provide a useful alternative.

### SUMMARY

The object of the present invention is addressed by the features of the independent claims. Further aspects of the inventive concept are defined in the dependent claims.

The present subject matter relates to systems and methods for generating an accurate hand pose by shifting an offset key point into a hand map without performing the brute-force search.

In an embodiment, there is provided a method for generating a hand pose which includes generating a hand map from an input image of a hand including a plurality of key points of the hand. The method also includes identifying at least one offset key point from the plurality of key points that are located outside the hand map. In addition, the method includes identifying a reference key point located inside the hand map and semantically closest to the at least one offset key point. The method also includes rotating the at least one offset key point along a path of rotation with the reference key point as a centre. Further, the method includes shifting the offset key point to a new position at an intersection of the path of the rotation and the hand map. Finally, the method includes generating the hand pose subsequent to shifting the offset key point to the new position within the intersection.

In another embodiment, there is provided a system to generate a hand pose is disclosed. The system includes a map-generating module adapted to generate a hand map from an input image of a hand using an image processing technique, wherein the hand map includes a plurality of key points of the hand. The system also includes an identification module adapted to identify at least one offset key point out of the plurality of key points located outside the hand map and identify a reference key point located inside the hand map and semantically closest to the at least one offset key point. In addition, the system includes a modification module adapted to rotate the at least one offset key point along a path of rotation with the reference key point as a centre and shift the offset key point to a new position at an intersection of the path of the rotation and the hand map. Finally, the system includes a hand-pose generation module adapted to generate the hand pose subsequent to shifting the offset key point to the new position within the intersection.

According to the present subject matter, the offset key point is rotated without disturbing other key points. As a result, the positions of the key points that are already inside the hand map are not altered. Moreover, the rotation of the offset key point and thereafter determination of the intersection of the key point with the hand map alleviate a need for a powerful computational resource. As a result, the aforementioned technique can be implemented on a small and compact computing device, such as a standalone AR/VR headset or a smartphone.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 shows an environment illustrating a system for generating a hand pose;

FIG. 2 illustrates a detailed schematic of the system for generating the hand pose;

FIG. 3 illustrates a generated hand map having a plurality of key points and 3-dimensional coordinates of the plurality of key points;

FIG. 4 illustrates an image with the plurality of key points including at least one offset key point and another image showing the rotation of the at least one offset key point along with a shifted position of the offset key point shown in phantom lines;

FIG. 5 illustrates a method for generating the hand pose;

FIG. 6 illustrates a method for generating the hand pose by rotating the offset key point; and

FIG. 7 illustrates a method for generating the hand pose by linearly moving the offset key point.

FIG. 8 illustrates a detailed schematic of the system for generating the hand pose.

FIG. 9 is a block diagram illustrating an electronic device in a network environment according to various embodiments.

FIGS. 10A and 10B are diagrams illustrating a wearable device (e.g., an electronic device or system) according to various embodiments of the disclosure.

### DETAILED DESCRIPTION

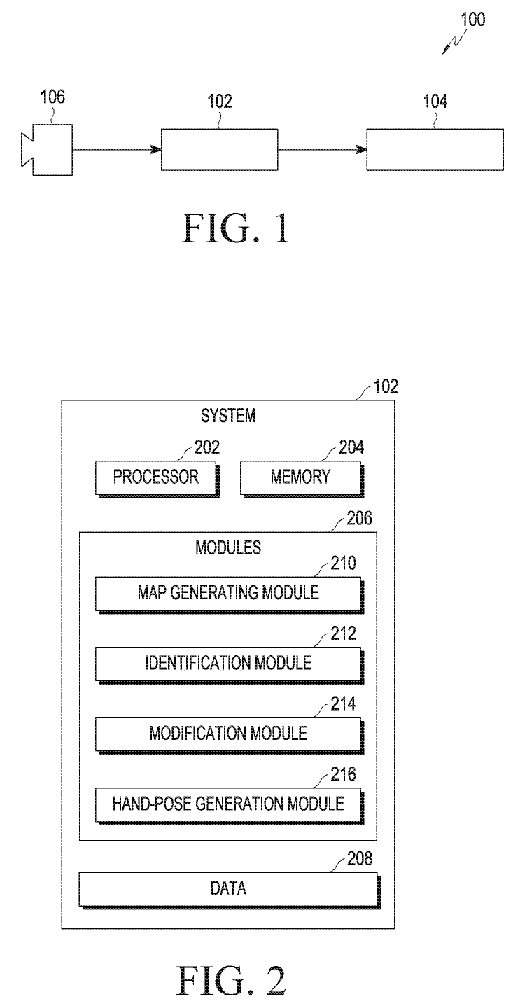

FIG. 1 illustrates an environment 100 illustrating a system 102 for generating a hand pose. The system 102 is configured to generate a hand pose in real time to digitize a hand gesture made by a user. The generated hand pose is used to simulate the movement of the hand in a virtual environment or in a video see-through (VST) application. In addition, the hand pose is used to perform an action, such as a picking-up operation in the virtual environment. In addition, the hand pose is used to simulate a typing operation or play a musical instrument in the virtual environment. The system 102 provides the digitized hand gesture in the form of the hand pose to a device 104. The device 104, in one example, is an augmented reality/virtual reality (AR/VR) headset or a display device. The system 102, in one example, is coupled to an image capture device 106 that captures an image of a user's hand. In some examples, the image capture device 106 is a Digital Single-Lens Reflex (DSLR) camera, smartphone camera, AR Glasses camera, or a stereoscopic camera, and generates an input image for the system 102 for further processing. In one example, the system 102 is implemented external to the device 104. In another example, the system 102, the device 104, and the image capturing device 106 is integrated as a single device, such as the AR/VR headset. In yet another example, the system 102, in part or as a whole, is integrated within one or more of the device 104 and the image capturing device 106.

The system 102, in an example, include various modules that, when operated, generate the hand pose. For example, the system 102 includes one or more of a map-generating module, an identification module, a modification module, and a hand-pose generation module, details of which are explained in detail in subsequent figures.

FIG. 2 illustrates a detailed schematic of the system 102 for generating the hand pose. The system 102 include different components that operate synergistically to generate the hand pose. For example, the system 102 include a processor 202, a memory 204, module(s) 206, and data 208. The memory 204, in one example, store the instructions to carry out the operations of the modules 206. In an example, the modules 206 and the memory 204 are coupled to the processor 202.

In an example, the processor 202 is a single processing unit or several units, all of which include multiple computing units. The processor 202 is implemented as one or more microprocessors, microcomputers, microcontrollers, digital signal processor, central processing units, state machines, logic circuitries, and/or any devices that manipulate signals based on operational instructions. Among other capabilities, the processor 202 is configured to fetch and execute computer-readable instructions and data stored in the memory 204.

The memory 204 include any non-transitory computer-readable medium known in the art including, for example, volatile memory 204, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The modules 206, amongst other things, include routines, programs, objects, components, data structures, etc., which perform particular tasks or implement data types. In some examples, the modules 206 is implemented as signal processor 202(s), state machine(s), logic circuitries, and/or any other device or component that manipulate signals based on operational instructions.

In some examples, the modules 206 are implemented in hardware, instructions executed by a processing unit, or by a combination thereof. In some examples, the processing unit comprise a computer, a processor, such as the processor 202, a state machine, a logic array, or any other suitable devices capable of processing instructions. In some examples, the processing unit is a general-purpose processor 202 which executes instructions to cause the general-purpose processor 202 to perform the required tasks or the processing unit is dedicated to performing the required functions. In another example, the modules 206 are machine-readable instructions (software) which, when executed by a processor 202/processing unit, perform any of the described functionalities. Further, the data serves, amongst other things, as a repository for storing data processed, received, and generated by one or more of the modules 206. The data 208 include information and/or instructions to perform activities by the processor 202.

The module(s) 206 perform different functionalities which include receiving information and generating the hand pose. Accordingly, in some examples, the module(s) 206 include a map-generating module 210, an identification module 212, a modification module 214, and a hand-pose generation module 216.

In one example, the map-generating module 210 is configured to receive the input image from the image-capturing device 106. The map-generating module 210 is configured to perform an object detection technique to detect the presence of a hand in the input image. The map-generating module 210 also performs a masking operation to generate a mask. In addition, the map-generating module 210, using an image segmentation technique, extract an edge of the hand from the input image to generate the hand map.

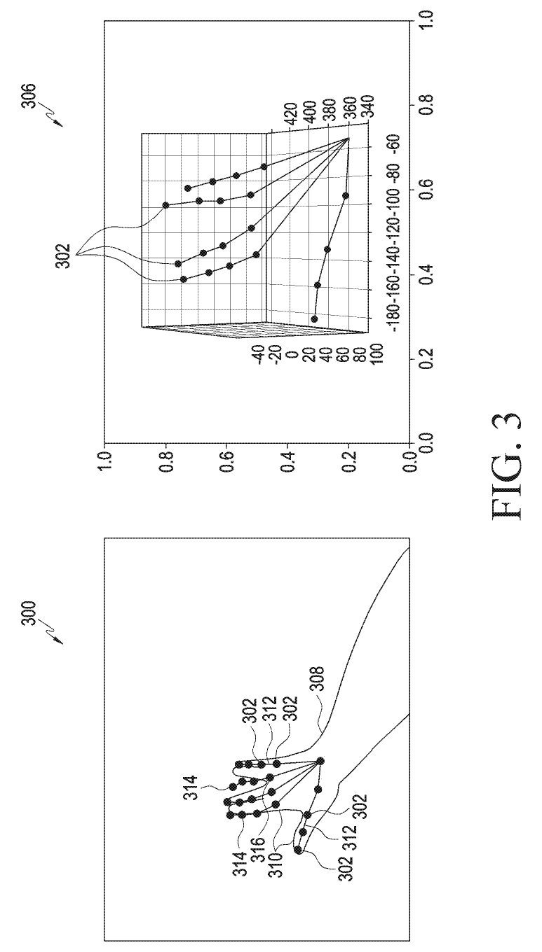

FIG. 3 illustrates a generated hand map 300 having a plurality of key points 302 and a 3-dimensional graph 306 showing the coordinates of the plurality of key points. As a part of generating the hand map, the map-generating module 210 identifies an edge of the hand 300 as the boundary of the hand map 300. In addition, the map-generating module 210 identifies a palm 308 of the hand and the plurality of fingers 310 that extends from the palm 308. In addition, the map-generating module 210 determines the plurality of key points 302. Accordingly, the map-generating module 210 identifies five sets of key points 302 for four fingers and one thumb of the hand. Once the key points 302 are identified, the map-generating module 210 also identifies a joint constraint 312 between two consecutive key points 302. As seen in FIG. 3, two consecutive key points 302 are connected by one joint constraint 312. In one example, the joint constraint 312 is analogous to the skeletal anatomy of the human hand.

In addition to the detection of the plurality of key points 302, the map-generating module 210 also determines a spatial position of each of the plurality of key points 302. In one example, the map-generating module 210 assigns an origin coordinate to a bottom left pixel of the hand map 300 and determine 3-D coordinates of the pixels of the plurality of key points 302. For instance, the map-generating module 210 extracts depth information from the input image to plot the coordinate in a cartesian coordinate system. In one example, a spherical coordinate system or cylindrical coordinate system is also employed. Further, the map-generating module 210 determines the shortest distance between two consecutive key points 302 to determine the length of the corresponding joint constraint 312. In addition, the map-generating module 210 also determines the coordinates of pixels having an edge of the hand map.

In one example, the determined spatial information of the plurality of key points 302 and the edge of the hand map, and lengths of all the joint constraints 312 is communicated to the identification module 212. In one example, the plurality of key points 302 includes at least one offset key point 314 and reference key point(s) 316. The at least one offset key point 314 is a key point located outside the hand map 300 whereas the reference point 316 is a key point located inside the hand map 300 and closest to the at least one offset key point 314. In one example, the reference key point 316 is a key point preceding the offset key point 314 in a kinematic tree of a finger. For example, if the offset key point 314 is the tip of the index finger, a corresponding reference key point 316 would be the joint between a tip and second last bones in the index finger.

Referring to FIG. 2, the identification module 212 is operably coupled to the map-generating module 210 and, in one example, is adapted to identify at least one key points, termed as at least one offset key point, that is not inside the hand map. The identification module 212 process the detected coordinates of the pixel corresponding to the at least one offset key point 314 to identify the at least one offset key point. In one example, the identification module 212 process the detected coordinates to check if the coordinates of the pixel of each key point 302 are within an enclosed area formed by the hand map 300. Further, the enclosed area formed by the hand map 300 include the pixels which are within the hand map 300. Accordingly, the identification module 212 checks if the coordinates of the pixel of the at least one key point 314 is corresponds to a pixel in the hand map 300. Upon checking, the identification module 212 identify at least one offset key point 314 that is outside the hand map as at least one offset key point 314 as shown in FIG. 3.

Upon identifying the at least one offset key point 314, the identification module 212 identify a key point 302 that is semantically positioned with respect to the offset key point 314. In one example, the semantically positioned key point 302 is a key point 302 that belongs to a set of key points 302 that belongs to a finger of the hand map 300. The identification module 212 determines the sets of key points 302 that forms the finger in the hand map 300. All the key points 302 that are within the hand map 300 are considered for determining the reference key point 316. In addition, the identification module 212 also identifies a key point 302 that is closest to the at least one offset key point 314. In one example, the closest key point 302 within the hand map 300 is an adjacent key point 302. In order to determine the reference key point 316, in one example, the identification module 212 determines lengths of all the joint constraints 312 between at least one offset key point 314 with the key points 302 within the hand map 300 and selects a key point 302 that has the shortest joint constraint 312. In one example, A key point 302 that fulfils the criteria of being semantically closest to the at least one offset key point 314 is termed as a reference key point 316. In one example, the reference key point 316 is used to shift the at least one offset key point 314 into the hand map. The identified at least one offset key point 314 and corresponding reference key point 316 are communicated to the modification module 214.

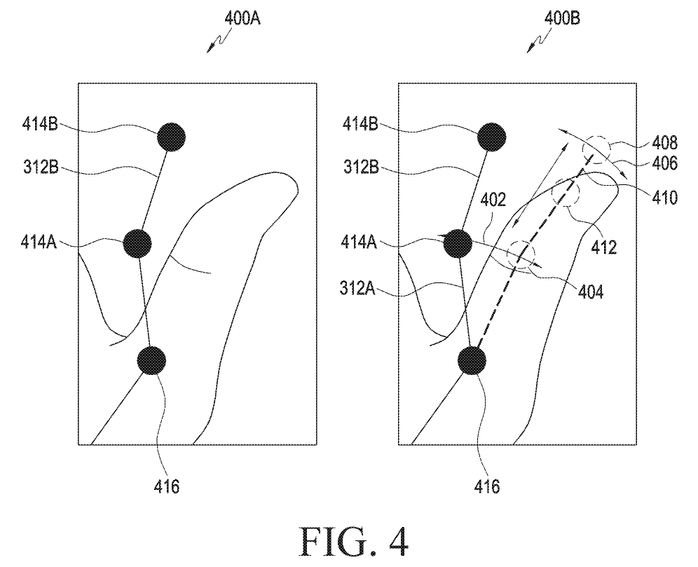

In one example, the modification module 214 is operably coupled to the identification module 212 and performs shifting of the offset key point 314 to move the offset key point 314 inside the hand map 300. The process is explained in conjunction with FIG. 4 that illustrates an image 400A with the plurality of key points 302 including at least one offset key point 314 and another image 400B showing the rotation of the at least one offset key point 314 along with a shifted position of the at least one offset key point 314 shown in phantom lines. In one example, the at least one offset key point 314 includes a first offset key point 314A and a second offset key point 314B. Referring to both FIGS. 2 and 4, the modification module 214 shift the at least one offset key point 314 by rotating or linearly moving the at least one offset key point 314 relative to the reference key point 316. In one example, the modification module 214 keeps the reference key point 316 as a centre, and thereafter rotate the first offset key point 314A of the at least one offset key point 314 in both clockwise and counterclockwise directions along a path of rotation 402. The path of rotation 402 maintains the length of the first joint constraint 312A between the reference key point 316 and the first offset key point 314A, as a constant. Further, during the rotation, the spatial orientation and length of the second joint constraint 312B of the second offset key point 314B relative to the first offset key point 314A remain unchanged. As a result, the rotation of the first offset key point 314A does not disturb the shifting of the second offset key point 314B.

In one example, the modification module 214 rotates the first offset key point 314A until the first offset key point 314A overlaps the hand map 300. In one example, the modification module 214 detects an intersection between the first offset key point 314A with an edge of the hand map 300 during the rotation. The modification module 214 detects the intersection by checking the coordinates of the first offset key point 314A after the rotation overlaps the coordinates of the edge of the hand map 300. Once the first offset key point 314A is inside the hand map 300, as shown in phantom circle 404, the modification module 214 checks if the second offset key point 314B is also outside the hand map 300. In case the second offset key point 314B is outside the hand map 300, the modification module 214 rotates the second offset key point 314B while keeping the reference key point 316 as the centre along another path of rotation 406. In other words, the modification module 214 keeps on rotating the second offset key point 314B until the second offset key point 314B intersects the edge of the hand map 300. In one example, the modification module 214 rotates the second offset key point 314B by 90 degrees in both clockwise and counterclockwise directions.

Where the second offset key point 314B is still outside the hand map 300 shown as phantom circle 408, the modification module 214 first repositions the second offset key point to an original position thereof. The original position, in one example, is a position that the second offset key point 314B attains after the first offset key point 314A is shifted into the hand map 300. The modification module 214 now reduce a length of the second joint constraint 312B depicted by the reduction length 410. The modification module 214 continues to reduce the length until the length reaches a minimum value. For example, the minimum value is 2 pixels. Simultaneously, the modification module 214 detects an intersection between the second offset key point 314B with the edge of the hand map 300. Once the modification module 214 detects the intersection, the modification module 214 stops the reduction of the length and assigns the new position, shown by another phantom circle 412, as a final position of the second offset key point 314B.

In one example, the modification module 214 performs rotation of the at least one offset key point 314 for each of the plurality of identified fingers 310. Once all the offset key points 314 are moved into the hand map 300, the modification module 214 determines the coordinates thereof and relay the same to the hand-pose generation module 216.

In one example, the hand-pose generation module 216, operably coupled to the modification module 214, receive the hand map 300 including the coordinates of the plurality of key points 302 that were inside the hand map 300 and the coordinates corresponding to new positions of the at least one offset key point 314 after the at least one key point 314 is moved into the hand map 300. Upon the receipt of the same, the hand-pose generation module 216 generates the hand pose using an image rendering technique that is relayed to the display device 104 shown in FIG. 1.

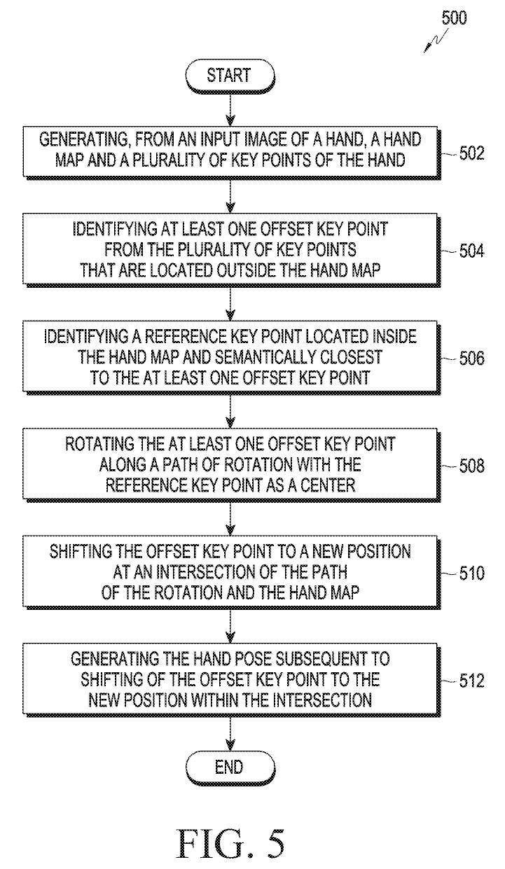

FIG. 5 illustrates a method 500 for generating a hand pose. The method 500 is performed by programmed computing devices, for example, based on instructions retrieved from non-transitory computer readable media. The computer readable media can include machine-executable or computer-executable instructions to perform all or portions of the described method. The computer readable media is, for example, digital memories, magnetic storage media, such as a magnetic disks and magnetic tapes, hard drives, or optically readable data storage media.

In one example, the method 500 is performed, partially or completely, by the system 102 shown in FIG. 2. The method begins at step 502, at which the map-generating module 210 generates the hand map 300 from the input image of a hand. The generated hand map 300 includes the plurality of key points 302. Further, at step 504, the identification module 212 identifies the at least one offset key point 314 that is located outside the hand map 300. At step 506, the identification module 212 identifies a reference key point 316 located inside the hand map 300 and is semantically closest to the at least one offset key point 314. Once the reference key point 316 is identified, the modification module 214, at step 508, rotates the at least one offset key point 314 along a path of rotation with the reference key point as a center. In addition, the modification module 214, at step 510, shortens a join constraint 312 between the at least one offset key point 314 and the reference key point to move the at least one offset key point 314 inside the hand map 300. Once the at least one key point 314 is moved inside the hand map 300, the hand-pose generation module 216, at step 512, generates the hand pose subsequent to shifting of the offset key point to the new position within the intersection.

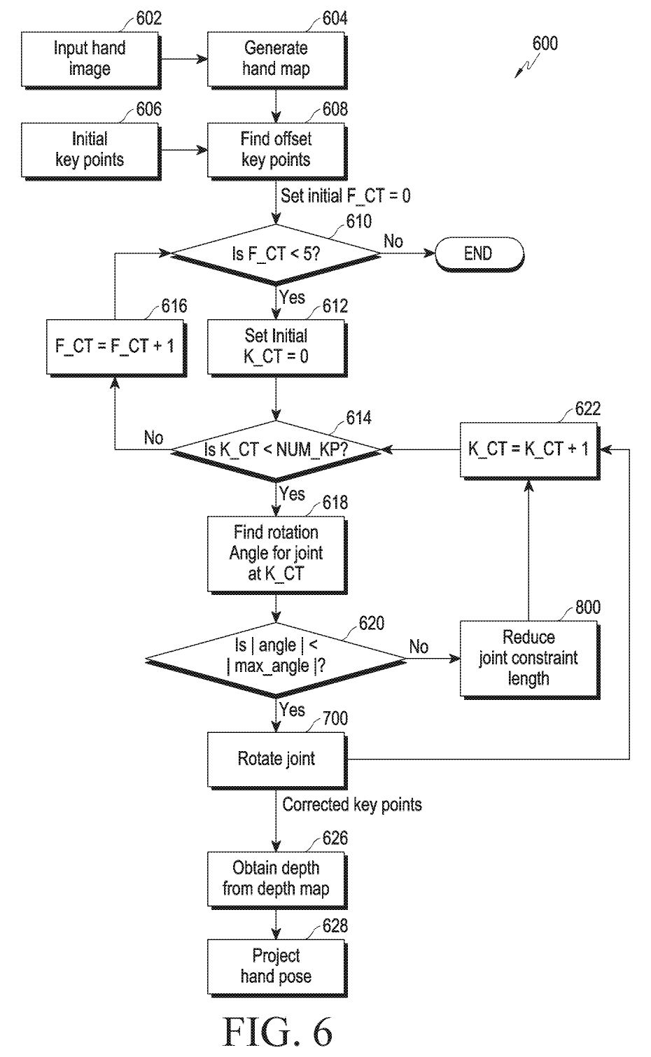

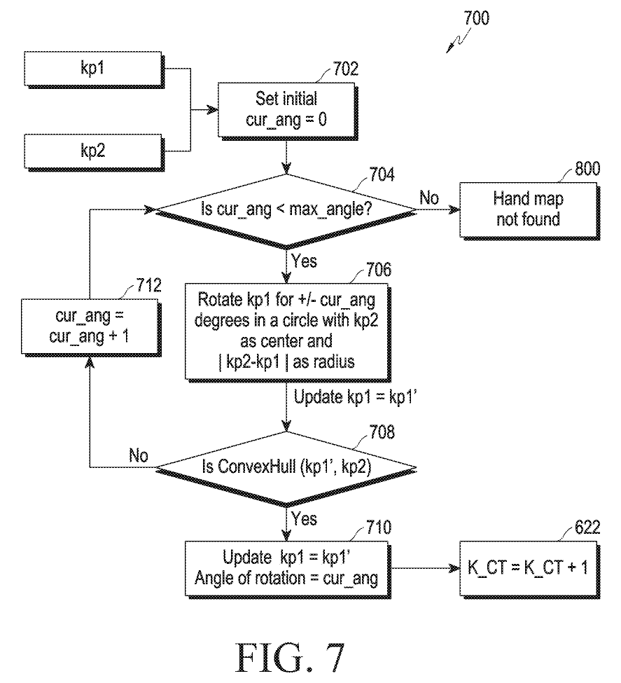

The aforementioned is explained in detail with respect to method illustrated in FIGS. 6 and 7. Specifically, FIG. 6 illustrates a method 600 for generating the hand pose by rotating the offset key point whereas FIG. 7 illustrates a method 700 for generating the hand pose by linearly moving the at least one offset key point.

Referring to FIG. 6, the method 600 begins at step 602 at which the input image is received. Thereafter, at step 604, the hand map is generated by the map generating module 210. In addition, at 606, the plurality of key points 302 are also identified. Both the hand map 300 and the plurality of key points 302 are communicated to the identification module 212. At step 608, the identification module 212 identifies offset key points 314 and reference key points 316 in a manner explained above. Once the offset key points 314 are identified, the modification module 214 sets a finger count (F_CT) to zero. Thereafter, at step 610, the modification module 214 checks with the F_CT is less than five. The F_CT is compared with the number five as five represents the number of fingers in the hand. In case the F_CT is greater than five, the method 600 ends with the conclusion that all the fingers are scanned. On the other hand, in case F_CT is less than five, the modification module 214, at step 612, sets the offset key point count (K_CT) to zero. The K_CT is the nth count of the offset key point 314.

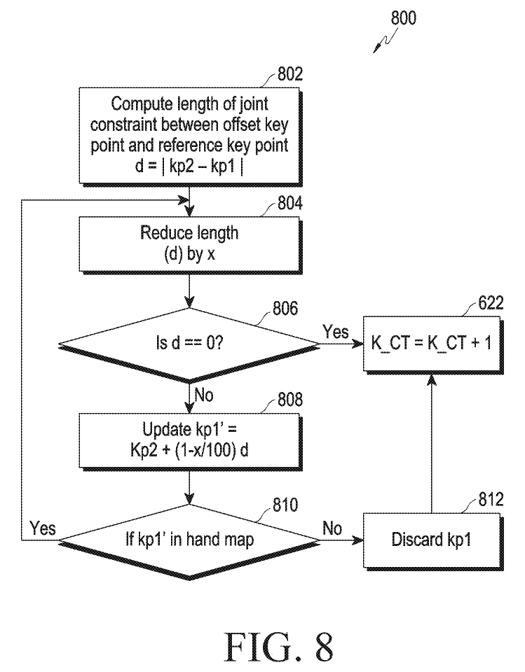

At step 614, the modification module 214 checks if the K_CT is less than the total number of offset key points (NUM_KP). In case the K_CT is less than NUM_KP, it is concluded that the at least one key point 314 is yet to be corrected. the method 600 proceeds to step 616, at which the F_CT is incremented by 1 and then returns to step 610. On the other hand, in case K_CT is greater than NUM_CP, the modification module 214, at step 618, finds an angle of rotation |angle| of for the offset key point 314 at the instantaneous K_CT and subsequently rotates the offset key point 314 by the angle of rotation. In one example, the modification module 214 rotates the offset key point 314 in both clockwise and counterclockwise directions and detects if the rotated offset key point has intersected the edge of the hand map 300. At step 620, the modification module 214 checks if the angle of rotation |angle| is less than a maximum angle of rotation |max_angle| and the intersection is detected, the offset key point is rotated to a new position by method 700 and thereafter, the method 600 then proceeds to step 622 at which the K_CT is incremented by 1 and the method 600 returns to step 614. However, in case the angle of rotation |angle| is greater than the maximum angle of rotation |max_angle| and the intersection is not detected, the modification module 214 reposition the offset key point kp1 to an original position thereof and proceeds to a method 800 which is explained in FIG. 8.

The above-mentioned steps are repeated until all the offset key points are corrected. Once the corrections are completed, the method 600 proceeds to step 626 at which the hand-pose generation module 216 obtains the depth of each key point from the depth map to generate the hand pose and renders a 3D image of the hand pose at step 628.

FIG. 7 illustrates a method 700 for rotating the at least one offset key point 314 relative to the reference key point 316. The method 700 begins at step 702 at which the modification module 214 receives the coordinates of the pixel of at least offset key point 314 (kp1) and the reference key point 316 (kp2) and the modification module 214 set an angle of rotation to be estimated (CUR_ANG) to zero. Thereafter, at step 704, the modification module 214 checks if the CUR_ANG is less than a maximum angle of rotation (MAX_ANG). In case the CUR_ANG is not less than MAX_ANG, the modification module 214 determines that the hand map 300 is not detected and method 700 proceeds to method 800. In case the CUR_ANG is less than MAX_ANG, the method 700 proceeds to step 706 at which the modification module 214 rotates the offset key point kp1 in both clockwise and counterclockwise direction by the CUR_ANG degree in a circle with kp2 as the center the joint constraint 312 between kp2 and kp1 as radius. Upon rotation, the modification module 214 updates the new coordinates of the new position, i.e., pixel kp1' as coordinates of the kp1.

Once the coordinates are updated, the modification module 214, at step 708, checks if the updated kp1' and the kp2 are within the hand map 300. As part of checking, the modification module 214 detects an intersection between the offset key point kp1 with an edge of the hand map 300 during the rotation. In case the updated kp1' and the kp2 are within the hand map 300, the method 700 proceeds to method 710, at which the modification module 214 stops the rotation of the offset key point kp1 when the offset key point kp1 intersects the edge of the hand map 300. Thereafter, the modification module 214 assigns new coordinates of kp1' to the kp1 (initial offset key point) and proceeds to step 622. In case the updated kp1' is not the hand map 300, the method 700 proceeds to step 712 at which the modification module 314 increments the CUR_ANG by 1 degree and returns to step 704.

FIG. 8 illustrates a detailed schematic of the system for generating the hand pose. Referring to FIG. 8, the method 800 begins at step 802, at which, the modification module 214 determines a length of a joint constraint 312 between the offset key point 314 (kp1) and the reference key point 316 (kp2) in the form of d =|kp2 - kp1|. Further, at step 804, the modification module 214 reduces the length by a factor x. In one example, the factor x is about 2% of the computed length d. Thereafter, at step 806, the modification module 214 checks if the length d is equal to zero. In case the length d is equal to zero, the modification module 214 determines that the offset key point 314 has overlapped the reference key point 316 and the method 800 ends and returns to step 622. In case the length d is not equal to zero, the modification module 214, at step 808, sets an updated position kp1' of the offset key point as kp1' = kp2 + (1-x/100)d.

Once updated, the modification module 214, at step 810, again checks if the updated offset key point kp1' position is within the hand map 300. In one example, the modification module 214, detects an intersection between the offset key point kp1 with an edge of the hand map 300 during the shortening of the length. In case the updated offset key point kp1' is still not in the hand map 300, the modification module 214 determines that the updated offset key point kp1' is not in the convex hull of the hand map 300 at step 812 and ultimately proceeds to step 622. On the other hand, in case the updated offset key point kp1' is still not in the hand map 300, the modification module 214 determines that the updated offset key point kp1' is not in the convex hull of the hand map 300 at step 812, the method returns to step 804 to repeat the process. The method 800 eventually proceeds to step 622 and subsequent steps are executed in a manner explained with respect to FIG. 6.

In an example, the offset key points 314 are accurately detected shifted with the help of the semantic and closest reference key point 316 which ensures that the shifting of the key point is performed accurately without disturbing other key points. As a result, the rendered hand pose is accurate. Moreover, since the system 102 determines the pixel coordinates of the edges of the hand map 300 and the plurality of key points 302 (including the offset key point 314 and the reference key point 316), the system 102 need not perform computationally resource-intensive brute-force search. Therefore, the system 102 and associated methods 500, 600, and 800 allow for accurate generation of the hand pose without using powerful computational resources.

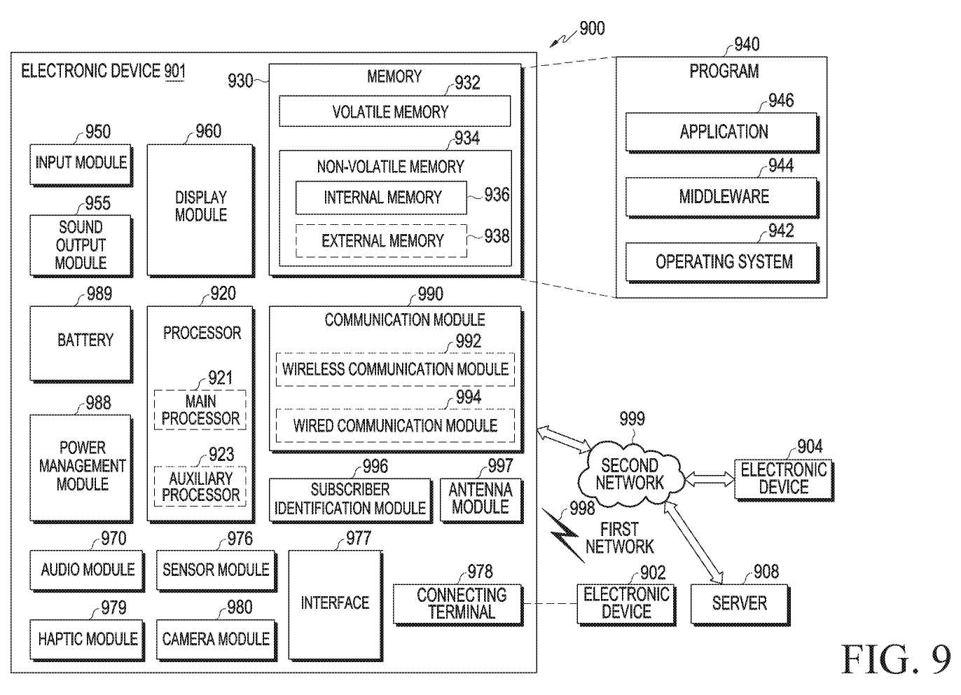

FIG. 9 is a block diagram illustrating an electronic device 901 in a network environment 900 according to various embodiments. Referring to FIG. 9, the electronic device 901 in the network environment 900 may communicate with an electronic device 902 via a first network 998 (e.g., a short-range wireless communication network), or at least one of an electronic device 904 or a server 908 via a second network 999 (e.g., a long-range wireless communication network). According to an embodiment, the electronic device 901 may communicate with the electronic device 904 via the server 908. According to an embodiment, the electronic device 901 may include a processor 920, memory 930, an input module 950, a sound output module 955, a display module 960, an audio module 970, a sensor module 976, an interface 977, a connecting terminal 978, a haptic module 979, a camera module 980, a power management module 988, a battery 989, a communication module 990, a subscriber identification module(SIM) 996, or an antenna module 997. In some embodiments, at least one of the components (e.g., the connecting terminal 978) may be omitted from the electronic device 901, or one or more other components may be added in the electronic device 901. In some embodiments, some of the components (e.g., the sensor module 976, the camera module 980, or the antenna module 997) may be implemented as a single component (e.g., the display module 960).

The processor 920 may execute, for example, software (e.g., a program 940) to control at least one other component (e.g., a hardware or software component) of the electronic device 901 coupled with the processor 920, and may perform various data processing or computation. According to one embodiment, as at least part of the data processing or computation, the processor 920 may store a command or data received from another component (e.g., the sensor module 976 or the communication module 990) in volatile memory 932, process the command or the data stored in the volatile memory 932, and store resulting data in non-volatile memory 934. According to an embodiment, the processor 920 may include a main processor 921 (e.g., a central processing unit (CPU) or an application processor (AP)), or an auxiliary processor 923 (e.g., a graphics processing unit (GPU), a neural processing unit (NPU), an image signal processor (ISP), a sensor hub processor, or a communication processor (CP)) that is operable independently from, or in conjunction with, the main processor 921. For example, when the electronic device 901 includes the main processor 921 and the auxiliary processor 923, the auxiliary processor 923 may be adapted to consume less power than the main processor 921, or to be specific to a specified function. The auxiliary processor 923 may be implemented as separate from, or as part of the main processor 921.

The auxiliary processor 923 may control at least some of functions or states related to at least one component (e.g., the display module 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). According to an embodiment, the auxiliary processor 923 (e.g., an image signal processor or a communication processor) may be implemented as part of another component (e.g., the camera module 980 or the communication module 990) functionally related to the auxiliary processor 923. According to an embodiment, the auxiliary processor 923 (e.g., the neural processing unit) may include a hardware structure specified for artificial intelligence model processing. An artificial intelligence model may be generated by machine learning. Such learning may be performed, e.g., by the electronic device 901 where the artificial intelligence is performed or via a separate server (e.g., the server 908). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 930 may store various data used by at least one component (e.g., the processor 920 or the sensor module 976) of the electronic device 901. The various data may include, for example, software (e.g., the program 940) and input data or output data for a command related thererto. The memory 930 may include the volatile memory 932 or the non-volatile memory 934.

The program 940 may be stored in the memory 930 as software, and may include, for example, an operating system (OS) 942, middleware 944, or an application 946.

The input module 950 may receive a command or data to be used by another component (e.g., the processor 920) of the electronic device 901, from the outside (e.g., a user) of the electronic device 901. The input module 950 may include, for example, a microphone, a mouse, a keyboard, a key (e.g., a button), or a digital pen (e.g., a stylus pen).

The sound output module 955 may output sound signals to the outside of the electronic device 901. The sound output module 955 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 960 may visually provide information to the outside (e.g., a user) of the electronic device 901. The display module 960 may include, for example, a display, a hologram device, or a projector and control circuitry to control a corresponding one of the display, hologram device, and projector. According to an embodiment, the display module 960 may include a touch sensor adapted to detect a touch, or a pressure sensor adapted to measure the intensity of force incurred by the touch.

The audio module 970 may convert a sound into an electrical signal and vice versa. According to an embodiment, the audio module 970 may obtain the sound via the input module 950, or output the sound via the sound output module 955 or a headphone of an external electronic device (e.g., an electronic device 902) directly (e.g., wiredly) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. According to an embodiment, the sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device (e.g., the electronic device 902) directly (e.g., wiredly) or wirelessly. According to an embodiment, the interface 977 may include, for example, a high definition multimedia interface (HDMI), a universal serial bus (USB) interface, a secure digital (SD) card interface, or an audio interface.

A connecting terminal 978 may include a connector via which the electronic device 901 may be physically connected with the external electronic device (e.g., the electronic device 902). According to an embodiment, the connecting terminal 978 may include, for example, a HDMI connector, a USB connector, a SD card connector, or an audio connector (e.g., a headphone connector).

The haptic module 979 may convert an electrical signal into a mechanical stimulus (e.g., a vibration or a movement) or electrical stimulus which may be recognized by a user via his tactile sensation or kinesthetic sensation. According to an embodiment, the haptic module 979 may include, for example, a motor, a piezoelectric element, or an electric stimulator.

The camera module 980 may capture a still image or moving images. According to an embodiment, the camera module 980 may include one or more lenses, image sensors, image signal processors, or flashes.

The power management module 988 may manage power supplied to the electronic device 901. According to one embodiment, the power management module 988 may be implemented as at least part of, for example, a power management integrated circuit (PMIC).

The battery 989 may supply power to at least one component of the electronic device 901. According to an embodiment, the battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the application processor (AP)) and supports a direct (e.g., wired) communication or a wireless communication. According to an embodiment, the communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as BluetoothTM, wireless-fidelity (Wi-Fi) direct, or infrared data association (IrDA)) or the second network 999 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The wireless communication module 992 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 992 may support a high-frequency band (e.g., the mmWave band) to achieve, e.g., a high data transmission rate. The wireless communication module 992 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 992 may support various requirements specified in the electronic device 901, an external electronic device (e.g., the electronic device 904), or a network system (e.g., the second network 999). According to an embodiment, the wireless communication module 992 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 997 may transmit or receive a signal or power to or from the outside (e.g., the external electronic device) of the electronic device 901. According to an embodiment, the antenna module 997 may include an antenna including a radiating element composed of a conductive material or a conductive pattern formed in or on a substrate (e.g., a printed circuit board (PCB)). According to an embodiment, the antenna module 997 may include a plurality of antennas (e.g., array antennas). In such a case, at least one antenna appropriate for a communication scheme used in the communication network, such as the first network 998 or the second network 999, may be selected, for example, by the communication module 990 (e.g., the wireless communication module 992) from the plurality of antennas. The signal or the power may then be transmitted or received between the communication module 990 and the external electronic device via the selected at least one antenna. According to an embodiment, another component (e.g., a radio frequency integrated circuit (RFIC)) other than the radiating element may be additionally formed as part of the antenna module 997.

According to various embodiments, the antenna module 997 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 901 and the external electronic device 904 via the server 908 coupled with the second network 999. Each of the electronic devices 902 or 904 may be a device of a same type as, or a different type, from the electronic device 901. According to an embodiment, all or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 901. The electronic device 901 may provide the outcome, with or without further processing of the outcome, as at least part of a reply to the request. To that end, a cloud computing, distributed computing, mobile edge computing (MEC), or client-server computing technology may be used, for example. The electronic device 901 may provide ultra low-latency services using, e.g., distributed computing or mobile edge computing. In another embodiment, the external electronic device 904 may include an internet-of-things (IoT) device. The server 908 may be an intelligent server using machine learning and/or a neural network. According to an embodiment, the external electronic device 904 or the server 908 may be included in the second network 999. The electronic device 901 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 940) including one or more instructions that are stored in a storage medium (e.g., internal memory 936 or external memory 938) that is readable by a machine (e.g., the electronic device 901). For example, a processor (e.g., the processor 920) of the machine (e.g., the electronic device 901) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStoreTM), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

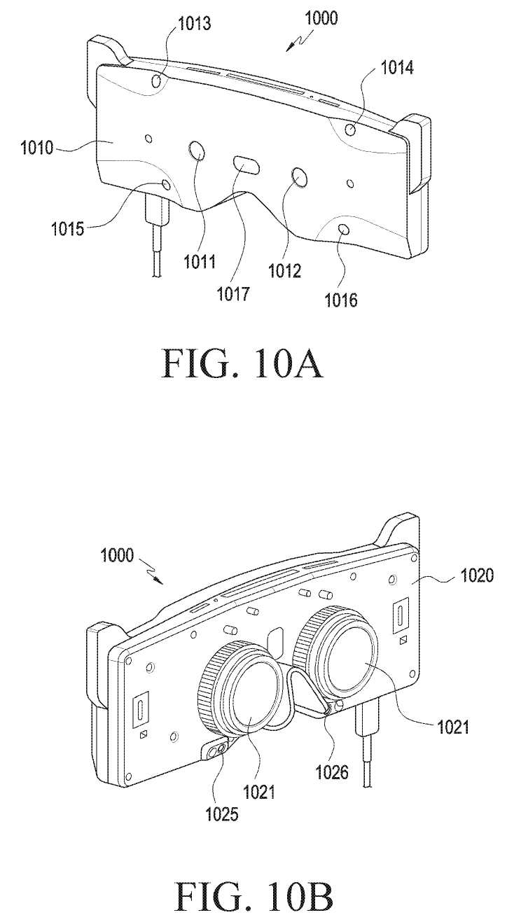

FIGS. 10A and 10B are diagrams illustrating a wearable device (1000)(e.g., an electronic device or system) according to various embodiments of the disclosure.

Referring to FIGS. 10A and 10B, in an embodiment, camera modules 1011, 1012, 1013, 1014, 1015, and 1016 and/or a depth sensor 1017 for obtaining information related to the surrounding environment of the wearable device 200 may be disposed on a first surface 1010 of the housing. In an embodiment, the camera modules 1011 and 1012 may obtain an image related to the surrounding environment of the wearable device. In an embodiment, the camera modules 1013, 1014, 1015, and 1016 may obtain an image while the wearable device is worn by the user. Images obtained through the camera modules 1013, 1014, 1015, and 1016 may be used for simultaneous localization and mapping (SLAM), 6 degrees of freedom (6DoF), 3 degrees of freedom (3DoF), subject recognition and/or tracking, and may be used as an input of the wearable electronic device by recognizing and/or tracking the user's hand. In an embodiment, the depth sensor 1017 may be configured to transmit a signal and receive a signal reflected from a subject, and may be used to identify the distance to an object, such as time of flight (TOF). According to an embodiment, face recognition camera modules 1025 and 1026 and/or a display 1021 (and/or a lens) may be disposed on the second surface 1020 of the housing. In an embodiment, the face recognition camera modules 1025 and 1026 adjacent to the display may be used for recognizing a user's face or may recognize and/or track both eyes of the user. In an embodiment, the display 1021 (and/or lens) may be disposed on the second surface 1020 of the wearable device 200. In an embodiment, the wearable device may not include the camera modules 1015 and 1016 among a plurality of camera modules 1013, 1014, 1015, and 1016. As described above, the wearable device according to an embodiment may have a form factor for being worn on the user's head. The wearable device may further include a strap for being fixed on the user's body and/or a wearing member (e.g., the wearing member 203). The wearable device may provide a user experience based on augmented reality, virtual reality, and/or mixed reality within a state worn on the user's head.

What is claimed is:

1. A method for generating a hand pose, the method comprising:
generating (502), from an input image of a hand, a hand map (300) and a plurality of key points (302) of the hand;
identifying (504) at least one offset key point (314, kp1) from the plurality of key points (302) that are located outside the hand map (300);
identifying (506) a reference key point (316, kp2) located inside the hand map (300) and is semantically closest to the at least one offset key point;
rotating (508) the at least one offset key point (314, kp1) along a path of rotation with the reference key point (316, kp2) as a center;
shifting (510) the offset key point (314, kp1) to a new position at an intersection of the path of the rotation and the hand map (300); and
generating (512) the hand pose subsequent to shifting of the offset key point (314, kp1) to the new position within the intersection.

2. The method as claimed in claim 1, wherein rotating the at least one offset key point comprises:
detecting an intersection between the at least one offset key point with an edge of the binary map during the rotation; and
stopping the rotation of the at least one offset key point when the at least one offset key point intersects the edge of the binary map.

3. The method as claimed in claim 1, further comprising:
determining that the at least one offset point is outside the binary map upon completion of the rotation of the at least one offset key point; and
repositioning the at least one offset key point to an original position thereof; and
reducing a length of a joint constraint between the at least one offset key point and the reference key point.

4. The method as claimed in claim 3, wherein reducing the length comprises:
detecting an intersection between the at least one offset key point with an edge of the hand map during the shortening of the length; and
stopping the shortening of the length when the at least one offset key point intersects the edge.

5. The method as claimed in claim 2, further comprising:
assigning the intersection as a new position of the at least one offset key point.

6. The method as claimed in claim 1, wherein generating the hand map comprises processing the input image using a semantic segmentation technique.

7. The method as claimed in claim 1, wherein generating the hand map comprises:
identifying a plurality of fingers of the hand and a corresponding plurality of key points.

8. The method as claimed in claim 7, wherein the rotation of the at least one offset key point is performed for each of the plurality of identified fingers.

9. A system to generate a hand pose, the system comprising:
a map-generating module (210) adapted to generate a hand map (300) from an input image of a hand using an image processing technique, wherein the hand map (300) includes a plurality of key points (302) of the hand;
an identification module (212) adapted to:
identify at least one offset key point (314, kp1) out of the plurality of key points (302) located outside the hand map (300), and
identify a reference key point (316, kp2) located inside the hand map (300) and is semantically closest to the at least one offset key point;
a modification module (214) adapted to:
rotate the at least one offset key point (314, kp1) along a path of rotation with the reference key point (316, kp2) as a center, and
shift the offset key point (314, kp1) to a new position at an intersection of the path of the rotation and the hand map (300); and
a hand-pose generation module (216) adapted to generate the hand pose subsequent to shifting of the offset key point (314, kp1) to the new position within the intersection.

10. The system as claimed in claim 9, wherein the modification module is adapted to:
detect an intersection between the at least one offset key point with an edge of the hand map during the rotation; and
stop the rotation of the at least one offset key point when the at least one offset key point intersects the edge of the hand map.

11. The system as claimed in claim 9, wherein the modification module is adapted to:
determine that the at least one offset key point is outside the hand map upon completion of the rotation of the at least one offset key point; and
reposition the at least one offset key point to an original position thereof; and
reduce a length of a joint constraint between the at least one offset key point and the reference key point.

12. The system as claimed in claim 11, wherein the modification module is adapted to:
detect an intersection between the at least one offset key point (with an edge of the hand map during the shortening of the length; and
stop the shortening of the length when the at least one offset key point intersects the edge.

13. The system as claimed in claim 10, wherein the modification module is further adapted to:
assign the intersection as a new position of the at least one offset key point.

14. The system as claimed in claim 9, wherein the image processing technique is semantic segmentation technique.

15. The system as claimed in claim 9, wherein the map-generating module is adapted to:
identify a plurality of fingers of the hand and corresponding plurality of key points.
